(19) United States
(12) Patent Application Publication
(10) Pub. No.: US 2016/0055082 A1
(43) Pub. Date: Feb. 25, 2016

(54) MEMORY ALLOCATING METHOD AND ELECTRONIC DEVICE SUPPORTING THE SAME

(71) Applicant: Samsung Electronics Co., Ltd., Gyeonggi-do (KR)

(72) Inventors: Jae Won Kim, Gyeonggi-do (KR); Chang Woo Min, Seoul (KR); Young Ik Eom, Gyeonggi-do (KR)

(21) Appl. No.: 14/823,766

(22) Filed: Aug. 11, 2015

(30) Foreign Application Priority Data
Aug. 20, 2014 (KR) 10-2014-0108620

(51) Int. Cl. G06F 12/02; G06F 12/08

(52) U.S. Cl. CPC G06F 12/0292; G06F 12/0802; G06F 2212/1041; G06F 2212/6042

(57) ABSTRACT

An electronic device, including an application configured to request a page allocation of a process, a cache management module configured to allocate a page in a page group including uninterrupted (or consecutive, or contiguous) pages to the process, and a page buffer configured to manage the at least one page group, is disclosed.

### CROSS-REFERENCE TO RELATED APPLICATION AND CLAIM OF PRIORITY

The present application relates to and claims the benefit under 35 U.S.C. §119(a) of a Korean patent application filed on Aug. 20, 2014 in the Korean Intellectual Property Office and assigned Serial number 10-2014-0108620, the entire disclosure of which is hereby incorporated by reference.

### TECHNICAL FIELD

The present disclosure relates to memory allocation.

### BACKGROUND

An electronic device like a general smart phone is usually designed to support various user functions in given dimensions and so needs to be efficiently managed in using a memory thereof. Moreover, in allocating a memory, such an electronic device is provided with a system for prearranging in advance a memory size necessary for operations of peripheral units, which are assigned to the memory, in purpose of stable operations with the peripheral units (e.g., a camera, and so on) connected to a main chip (e.g., CPU). In the system management, a prearranged memory related to an operation of the peripheral unit cannot be used for another user function. For that reason, when peripheral units assigned to a memory are being inoperative, the memory may be redundant to dissipate resources in the electronic device. In regard to that, there has been provided an input/output memory management unit (IOMMU) to support a system to increase available memory resources without modifying a physical memory arrangement thereof.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### SUMMARY

Because a processor based on such an above-mentioned IOMMU operates to allocate available memories independent from the physical memory arrangement, there could seriously arise a problem of external fragment for memories. Furthermore, even when a buddy allocator operates to secure a large memory capacity from a memory configuration, which is conditioned in much of external fragmentation, based on small capacity memories, there could be still a problem of relatively requiring much delay time therefor.

Accordingly, embodiments of the present disclosure are to address at least the above-mentioned problems and/or disadvantages, and thus provide a memory allocating method an electronic device provide a memory allocating method and an electronic device supporting the method.

In accordance with various embodiments of the present disclosure, an electronic device includes an application to request page allocation of a process, a cache management module to allocate pages in page groups which include uninterrupted (or consecutive, or contiguous) pages to the process, and a page buffer to manage at least one of the pages.

According to various embodiments of the present disclosure, it is accomplishable to improve memory efficiency by reducing a rate of external fragmentation in a memory allocating operation of an electronic device, thereby raising a speed of response for memory.

Other embodiments, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment of an electronic device, which supports reducing external fragmentation in accordance with various embodiments of the present disclosure;

FIG. 2 illustrates a configuration of a memory management module in accordance with various embodiments of the present disclosure;

FIG. 3 illustrates a memory allocating method according to various embodiments of the present disclosure;

FIG. 4 illustrates another example of management module according to embodiments of the present disclosure;

FIG. 5 illustrates page variations relevant to memory allocation according to various embodiments of the present disclosure;

FIG. 6 illustrates page variations of a freed memory according to various embodiments of the present disclosure;

FIG. 7 illustrates page variations of a system memory according to various embodiments of the present disclosure;

FIG. 8 illustrates another example of an electronic device related to memory allocation according to various embodiments of the present disclosure; and

FIG. 9 illustrates a block diagram of a program module according to various embodiments of the present disclosure.

Throughout the drawings, it should be noted that like reference numbers are used to depict the same or similar elements, features, and structures.

### DETAILED DESCRIPTION

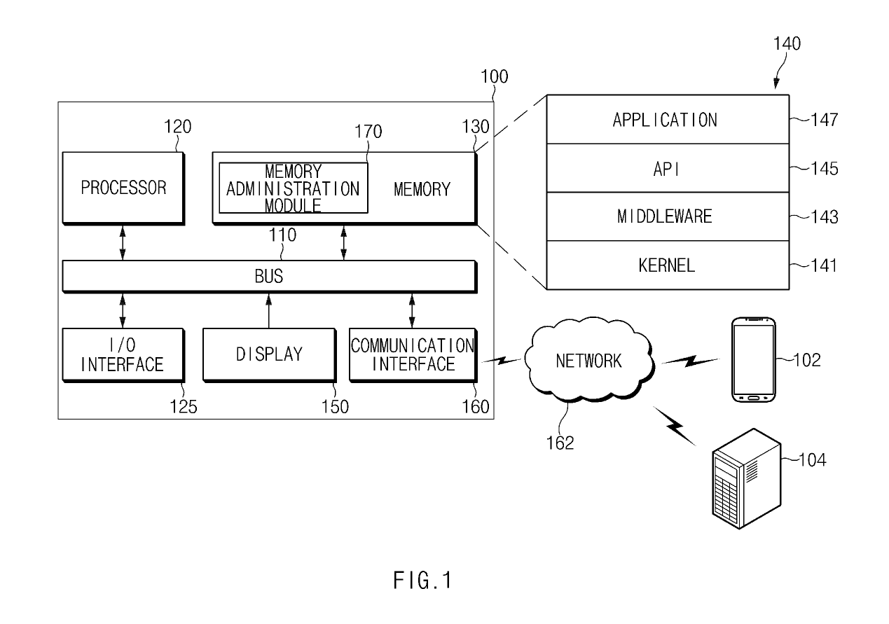

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication device.

Hereinafter, various embodiments of the present disclosure will be described in conjunction with the accompanying drawings. Various embodiments described herein, however, may not be intentionally confined in specific embodiments, but should be construed as including diverse modifications, equivalents, and/or alternatives. With respect to the descriptions of the drawings, like reference numerals refer to like elements.

The terms “have,” “may have,” “include,” “may include,” “comprise,” or “may comprise” used herein indicate existence of corresponding features (e.g., numerical values, functions, operations, or components) but does not exclude other features.

As used herein, the terms “A or B,” “at least one of A or/and B,” or “one or more of A or/and B” include all allowable combinations which are enumerated together. For example, the terms “A or B,” “at least one of A and B,” or “at least one of A or B” indicate all cases of: (1) including at least one A, (2) including at least one B, or (3) including both at least one A, and at least one B.

As used herein, the terms such as “1^{st},” “2^{nd},” “first,” “second,” and the like are used to qualify various elements regardless of their order and/or priority, simply differentiating one from another, but do not limit those elements thereto. For example, both a first user device and a second user device indicate different user devices. For example, a first component may be referred to as a second component and vice versa without departing from the scope of the present disclosure.

As used herein, when one element (e.g., a first element) is referred to as being “operatively or communicatively connected with/to” or “connected with/to” another element (e.g., a second element), it should be understood that the former is directly coupled with the latter or connected with the latter via an intervening element (e.g., a third element). Otherwise, it will be understood that when one element is referred to as being “directly coupled with/to” or “directly connected with/to” with another element, it is understood that there is no intervening element existing between them.

In the description or claims, the term “configured to” (or “set to”) is changeable with other implicative meanings such as “suitable for,” “having the capacity to,” “designed to,” “adapted to,” “made to,” or “capable of,” and may not simply indicate “specifically designed to.” In certain embodiments, a term “a device configured to” indicates that the device “may do” something together with other devices or components. For instance, a term “a processor configured to (or set to) perform A, B, and C” indicates a generic-purpose processor (e.g., CPU or application processor) capable of performing its related operations by executing one or more software or programs which is stored in an exclusive processor (e.g., embedded processor), which is prepared for the operations, or in a memory.

The terms used in this specification are just used to describe various embodiments of the present disclosure and are not intended to limit the scope of the present disclosure. The terms of a singular form include plural forms unless otherwise specified. Unless otherwise defined herein, all the terms used herein, which include technical or scientific terms, have the same meaning that is generally understood by a person skilled in the art. It will be further understood that terms, which are defined in a dictionary and commonly used, should also be interpreted as is customary in the relevantly related art and not in an idealized or overly formal detect unless expressly so defined herein in various embodiments of the present disclosure. In some cases, terms even defined in the specification may not be understood as excluding embodiments of the present disclosure.

An electronic device according to various embodiments of the present disclosure includes, for example, at least one of smartphones, tablet personal computers (tablet PCs), mobile phones, video telephones, electronic book readers, desktop PCs, laptop PCs, netbook computers, workstations, servers, personal digital assistants (PDAs), portable multimedia players (PMPs), MP3 players, mobile medical devices, cameras, wearable devices (e.g., electronic glasses, or head-mounted-devices (HMDs), electronic apparel, electronic bracelets, electronic necklaces, electronic appcessories, electronic tattoos, smart watches, and the like.

In various embodiments, an electronic device is a smart home appliance. The smart home appliance includes at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., SAMSUNG HOMESYNC, APPLE TV, GOOGLE TV, and the like), game consoles, electronic dictionaries, electronic keys, camcorders, electronic picture frames, and the like.

In various embodiments of the present disclosure, an electronic device includes at least one of diverse medical devices (e.g., portable medical measuring instruments (blood-sugar measuring instruments, heart-pulsation measuring instruments, blood-pressure measuring instruments, or body-temperature measuring instruments), magnetic resonance angiography (MRAs) equipment, magnetic resonance imaging (MRI) equipment, computed tomography (CT) equipment, scanners, and ultrasonic devices), navigation device, global positioning system (GPS) receiver, event data recorder (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs) for financial agencies, points of sales (POSs) for stores, and internet of things (e.g., electric bulbs, diverse sensors, electric or gas meter, spring cooler units, fire alarms, thermostats, road lamps, toasters, exercise implements, hot water tanks, boilers, and the like).

According to various embodiments of the present disclosure, an electronic device includes at least one of parts of furniture or buildings/structures having communication functions, electronic boards, electronic-signature receiving devices, projectors, and diverse measuring instruments (e.g., water meters, electricity meters, gas meters, and wave meters) including metal cases. In various embodiments of the present disclosure, an electronic device is one or more combinations of the above-mentioned devices. Electronic devices according to various embodiments of the present disclosure are flexible devices. Electronic devices according to various embodiments of the present disclosure may not be restrictive to the above-mentioned devices, rather includes new electronic devices emerging by way of technical development.

Hereinafter, an electronic device according to various embodiments of the present disclosure will be described in more detail with reference to the accompanying drawings. In description for various embodiments of the present disclosure, the term “user” refers to a person using an electronic device or a device using an electronic device (for example, an artificial intelligent electronic device).

FIG. 1 illustrates a network environment of an electronic device, which supports reducing external fragmentation, in accordance with various embodiments of the present disclosure.

Referring to FIG. 1, a network environment in various embodiments includes an electronic device 100, a network 162, another electronic device (hereinafter referred to as “second electronic device”) 102, and a server system 104.

In the network environment, the electronic device 100, in relation to user function assistance, forms communication channels with the second electronic device 102 and the server system 104 through the network 162 and receives data from the second electronic device 102 or the server system 104. The electronic device 100 performs memory allocation (e.g., page allocation with a size) that is related to user function assistance, and memory allocation that is related to processing of received data. According to various embodiments, the electronic device 100 performs memory allocation, which is needed for an operation of a system or an operation of a user function, based on a unit page (or a page frame or a page, e.g., 4 KB (kilobytes) in size) of a size that is specified by a kernel.

According to various embodiments, the electronic device 100 includes a memory management module 170 and performs memory allocation, which is related to execution of at least one process, in correspondence with control of a processor 120. During this operation, the memory management module 170 designates or arranges at least one page group, which is formed of pages series or consecutive pages (pages where unit pages are contiguously arranged in a physical memory), for execution of one process to lessen external fragmentation. Additionally, the memory management module 170 receives and processes a page group during page restoration in correspondence with process termination. Based on this operation, the memory management module 170 retains and manages contiguous pages (or interrupted pages, or consecutive pages, or page series) in relatively large amount and thereby supports to provide the contiguous pages while executing a large capacity of a process.

The network 162 includes a telecommunications network such as at least one of computer network (e.g., LAN or WLAN), internet, and telephone network. The network 162 supports communication channel formation in relation to an operation of a communication service. The electronic device 100 performs memory allocation related to communication channel formation, and memory allocation related to processing of data transmitted and received through a communication channel.

The second electronic device 102 is the same with or another kind of the electronic device 100. The second electronic device 102 transmits a call connection request message to the electronic device 100 through the network 162 or forms a communication channel that is requested for message transmission. The electronic device 100 installs and employs an application, which can support functions for communication connection or message exchange with the electronic device 102. For employing the installed application, the electronic device 100 executes at least one process. At least one process is allocated with a unit page from a page group as described above.

According various embodiments, the server system 104 includes one or more server groups. According to various embodiments, all or a part of operations executed in the electronic device 100 may be performed in another or a plurality of electronic device (e.g., the second electronic device 102 or the server system 104). The server system 104 forms a communication channel with the electronic device 100 or the second electronic device 102 in relation to data service support. The server system 104 transmits data to the electronic device 100 through the formed communication channel. The electronic device 100 performs memory allocation related to processing of received data, in which at least one or more unit pages provided from at least one page group is allocated for a process related to data processing.

According to various embodiments, if a function or service is performed automatically or by a request, the electronic device 100 requests another electronic device (e.g., the second electronic device 102 or the server system 104) to perform at least a part of the function or service in addition to or instead of performing the function or service by itself. Another electronic device (e.g., the second electronic device 102 or the server system 104) performs the requested or additional function and transmits a result of the function to the electronic device 100. The electronic device 100 directly or additionally processes a received result to provide the requested function or service. To this end, for example, it is permissible to use cloud computing, dispersion computing, or client-server computing technology.

A bus 110 of the electronic device 100, for example, connects the elements 120 to 160 each other and includes a circuit for conveying communication (e.g., control messages and/or data) between the elements. For example, the bus 110 transfers a control signal of the processor 120 to the memory management module 170 of a memory 130. The bus 110 transfers a processing result of the processor 120 to an application. Additionally, the bus 110 transfers the processing result to a display 150 or a communication interface 160.

The processor 120 includes at least one of an application processor (AP), a communication processor (CP), or a central processing unit (CPU). The processor 120, for example, executes computation or data operation related to control or communication for at least one of other elements. According to various embodiments, the processor 120 supports an operation of the memory management module 170. For example, the processor 120 supports a computing operation that is needed to employ a kernel 141 disposed in the memory 130. The processor 120 includes at least one processor in relation to a program 140 of the memory 130 or memory allocation of the memory management module 170. The electronic device 100 includes a plurality of processors in accordance with design methodology. One processor or one CPU employs a hot/cold cache for efficiency of memory allocation and retrieval.

The memory 130 includes a volatile or nonvolatile memory. The memory 130 stores, for example, instructions or data, which are involved in at least one of other elements in the electronic device 100, therein. The memory 130 stores software or the program 140 therein. The program 140 includes, for example, a kernel 141, a middleware 143, an application programming interface (API) 145, or an application program (or “application”) 147. At least a part of the kernel 141, the middleware 143, or the API 145 is referred to as an operating system (OS).

The kernel 141 controls or manages, for example, system resources (e.g., the bus 110, the processor 120, or the memory 130) which are used for executing operations or functions implemented in other programs (e.g., the middleware 143, the API 145, or the application program 147). Additionally, the kernel 141 provides an interface capable of controlling or managing system resources by approaching individual elements of the electronic device 100 from the middleware 143, the API 145, or the application program 147. According to various embodiments, the kernel 141 allocates a physical memory in the unit of unit page with a size (e.g., 4 kB) that is specified in relation to memory allocation. With respect to memory allocation, the kernel 141 supports the loading and operating of the memory management module 170.

The middleware 143 performs a mediating function to allow, for example, the API 145 or the application program 147 to communicate and exchange data with the kernel 141. Additionally, in relation to work requests received from the application program 147, the middleware 143 performs, for example, a control operation (e.g., scheduling or load balancing) for the work request by using a method of designating or arranging the priority, which permits the electronic device 101 to use a system resource (e.g., the bus 110, the processor 120, or the memory 130), into at least one application of the application program 147. According to various embodiments, the middleware 143 transfers a change of communication state, e.g., information about a change in activation period, maintenance period, or standby period, to the kernel 141, and supports an API calling in relation to each periodic operation. The middleware 143 includes the memory management module 170.

The API 145 is, for example, an interface to allow the application 147 to control a function which is provided from the kernel 141 or the middleware 143. For example, the API 145 includes at least one interface or function (e.g., an instruction) for file control, window control, or character control.

According to various embodiments, the memory 130 includes the memory management module 170. The memory management module 170 controls memory allocation of the memory 130. For example, the memory management module 170 classifies sectors of the memory 130 in the unit of 4 kB and disposes diverse programs, which are needed to employ the electronic device 100, respectively in the sectors. During this operation, the memory management module 170 designates or arranges unit pages (e.g., a page group), which are contiguously disposed in physical structure, for one process execution. The memory management module 170 designates or arranges unit pages for a specific process execution. For example, the memory management module 170 allocates unit pages, which do not belong to a page group, when unit pages of page groups among a page chunk (the specific number of pages, e.g., 31 pages) that is allocated to the processor 120, such as CPU, are all allocated for process execution. After a specific process is terminated, the memory management module 170 retrieves or restores a unit page or a page group that is allocated for the process execution corresponding thereto.

An input/output (I/O) interface 125 serves as, for example, an interface capable of transferring instructions or data, which are input from a user or another external device, to another element (or other elements) of the electronic device 100. Additionally, the I/O interface 125 outputs instructions or data, which are received from another element (or other elements) of the electronic device 100, to a user or another external device. The I/O interface 125 generates an input signal for activating at least one application. If an application related to an operation of at least one user function is activated, the memory management module 170 performs anonymous page allocation in relation to an operation of an application corresponding thereto.

The display 150 includes, for example, a liquid crystal display (LCD), a light emitting diode (LED), an organic LED (OLED) display, a microelectromechanical system (MEMS) display, or an electronic paper. The display 150 displays, for example, diverse contents (e.g., text, image, video, icon, or symbol) to a user. The display 150 includes a touch screen, and for example receives an input of touch, gesture, approach, or hovering that is made by using an electronic pen or a part of a user's body.

According to various embodiments, the display 150 outputs a picture related to file regeneration. While a regenerated file is output into the display 150, the memory 130 supports buffering of the files to be regenerated. During this operation, the memory 130 processes a page cache to help a fast progress of file regeneration or file search during file regeneration. The electronic device 100 controls the memory 130 to store images that are related to diverse pictures output into the display 150.

The communication interface 160 sets, for example, a communication condition between the electronic device 100 and an external electronic device (e.g., the second electronic device 102 or the server system 104). For example, the communication interface 160 communicates with an external electronic device (e.g., the second electronic device 102 or the server system 104) in connection with the network 162 through wireless communication (or local wireless communication) or wired communication. The wireless communication uses, for example, at least one of LTE, LTE-A, CDMA, WCDMA, UMTS, WiBro, or GSM. The wired communication includes, for example, at least one of universal serial bus (USB), high definition multimedia interface (HDM), recommended standard 232 (RS-232), or plain old telephone service (POTS). The local wireless communication includes a communication mode based on BLUETOOTH communication module or WiFi direct communication.

The communication interface 160 receives data (e.g., motion picture image, still image, and the like) under control of the processor 120. Data received through the communication interface 160 is stored in the memory 130. During this, data received through the communication interface 160 is processed by at least one process. At least one page group is designated or arranged in at least one process and a unit page is allocated in the designated page group.

The memory management module 170 controls allocation of the memory 130. For example, the memory management module 170 classifies the memory 130 into arrangement of unit pages and support contiguous pages to be designated or arranged into at least one process. In allocating a large capacity of pages, the memory management module 170 allocates relatively large page groups each with a relatively small number.

The electronic device 100 further includes a camera module. If the camera module is activated, the memory management module 170 allocates unmovable memory sectors in relation to an operation of the camera module. In the same manner, the electronic device 100 further includes a peripheral device (e.g., connectable external device, printer, or sensor). The memory management module 170 performs page allocation, which is involved in hardware, in the form of unmovable memory.

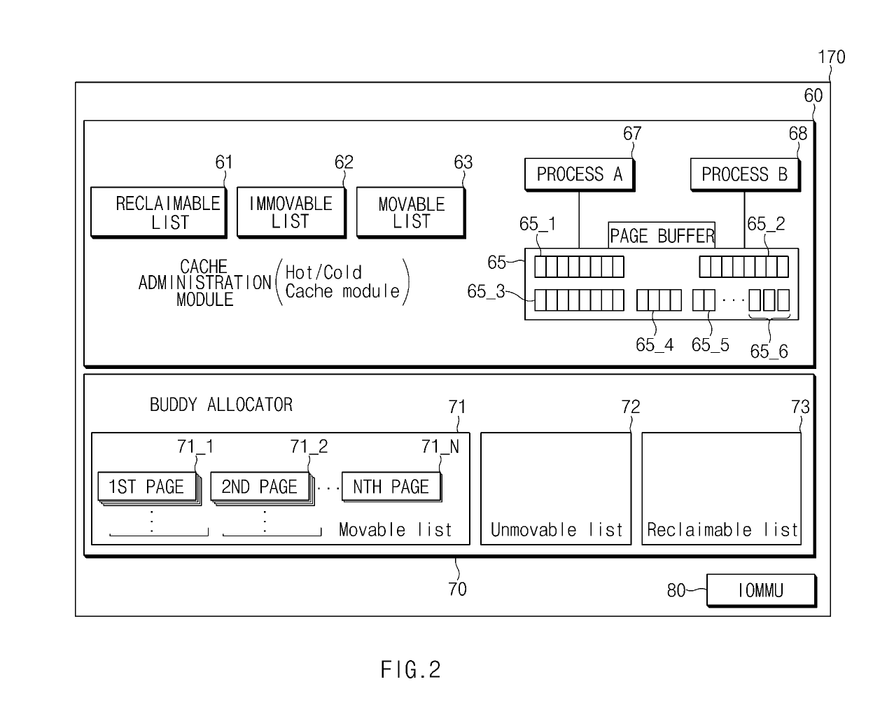

FIG. 2 illustrates a configuration of a memory management module in accordance with various embodiments of the present disclosure.

Referring to FIG. 2, the memory management module 170 includes a buddy allocator 70 and a cache management module 60. The memory management module 170 includes an input/output memory manager 80. The buddy allocator 70 manages page frames of physical memory sectors in a specific size, e.g., in the size of an order (multiplier, e.g., 2N) of unit pages each of which is sized in 4 kB. The buddy allocator 70 includes a movable list manager 71, an unmovable list manager 72, and a reclaimable list manager 73.

The movable list manager 71 manages a list of movable pages among pages which are stored in the memory 130. The movable page means a unit page which is changeable in physical location in control of the kernel 141. The movable list manager 71 manages at least one of movable pages in location and number. Page caches and anonymous pages, among pages allocated in the memory 130, are movable pages.

According to various embodiments, the movable list manager 71 classifies and manages movable pages by an order in accordance with sizes thereof. For example, the movable list manager 71 manages at least one movable page 71_1 sized in one unit page (e.g., 21 in number), among movable pages, at least one movable page group 71_2 sized in two contiguous unit pages (e.g., 21 in number), . . . , and at least one movable page group 71_N sized in N-numbered contiguous unit pages (e.g., 210 in number). The movable list manager 71 provides at least one of the movable page 71_1, the movable page group 71_2, . . . , the movable page group 71_N, those of which are classified in a specific order, if the cache management module 60 requests a page chunk which includes unit pages with a specific number.

According to various embodiments, the movable list manager 71 provides the movable page 71_1 by a specific number, e.g., 31, to fit the number of page chunks. If the number of the movable pages 71_1 is smaller than or equal to 31, the movable list manager 71 provides the movable page group 71_2 to the cache management module 60. If the total number of unit pages in summation with the movable page 71_1 and the page group 71_2 is smaller than or equal to 31, the movable list manager 71 provides a third movable page group, which is sized in four contiguous unit pages (e.g., 22 in number), to the cache management module 60. During this, the movable list manager 71 splits the page group into 31 to complete the desired number of unit pages. The split page groups or unit pages are rearranged as the movable page 71_1 or the movable page group 71_2 in accordance with its size corresponding thereto (the number of contiguous unit pages).

With regard to an operation of a specific application based on the movable list manager 71 described above, the kernel 141 allocates at least one unit page. These unit pages are arranged in a random or specific algorithm and be in external fragmentation by their arrangement circumstances. In the circumstances, the kernel 141 needs contiguous pages with a size in relation to an operation of a specific application or specific application. The kernel 141 changes a location of a movable one of unit pages, which are arranged at a specific location of the memory 130, to secure contiguous pages.

The unmovable list manager 72 manages a memory sector in which unmovable pages are allocated. Unmovable pages are pages that are not allowed to move their locations in a physical memory structure or that cause a high cost for changing their locations. For example, the unmovable pages are designated or arranged in relation to operations of hardware units of the electronic device 100. According to various embodiments, if there is a request for camera module activation, the kernel 141 provides physical pages, which are involved in their corresponding camera module, to an unmovable page. The unmovable list manager 72 performs the same management with the movable list manager 71 for unmovable pages. For example, the movable list manager 71 classifies and manages at least one first unmovable unit page, at least one second unmovable page group (e.g., pages with two contiguous unit pages), at least one third unmovable page group (e.g., pages with four contiguous unit pages), . . . , and at least one Nth unmovable page group (e.g., pages with N contiguous unit pages). The unmovable list manager 72 is requested for memory allocation in relation to an operation of a hardware unit without using the cache management module 60. Otherwise, unmovable page allocation of unit page size is requested from the cache management module 60. The unmovable list manager 72 provides required pages in response to a request corresponding thereto.

The reclaimable list manager 73 manages root information or chain information in relation to file storage. The reclaimable list manager 73 supports allocation of pages in connection with the processing of information relevant thereto. In this operation, similar to the movable list manager 72 or the unmovable list manager 72, the reclaimable list manager 73 classifies and manages pages in their contiguous size.

The cache management module 60, as a hot/cold cache module or a per CPU page (PCP), allocates pages that are needed for process performance. With respect to this, the cache management module 60 obtains a page chunk of a specific size (e.g., 31 pages) from the buddy allocator 70. The cache management module 60 checks and classifies page groups that belong to an obtained page chunk. The cache management module 60 checks a process that is to be performed and allocates pages or page groups each by processes.

According to various embodiments, the cache management module 60 designates or arranges randomly, or designates or arranges a specific-sized or the largest page (or a page group formed of the most contiguous pages) to a process that is to be first performed. The cache management module 60 allocates a unit page, which belongs to a page group, to a corresponding process after designating or arranging a page group. The cache management module 60 allocates another page group in relation to another process performance and allocates a unit page, which belongs to another page group, for another process performance. In regard to this, the cache management module 60 includes a page buffer 65, a process 67, and a process 68. The process 67 or the process 68, as an example of at least one process which is performed in the electronic device 100, is provided with memory allocation by the cache management module 60 in number of one process or more number of processes. The process 67 or the process 68 is, for example, a process which is designated according to execution of different applications. Otherwise, the process 67 or the process 68 is a process related to operations of different functions in employing one application. One process is executed based on at least one unit page. According to various embodiments, a process is allocated with more pages during an operation thereof. The cache management module 60 allocates a page in a page group that contains contiguous pages to one process.

The page buffer 65 manages pages that are obtained from the buddy allocator 70. According to various embodiments, the page buffer 65 even manages only page groups among pages which are obtained from the buddy allocator 70. During this, pages of unit page (e.g., pages in the order 0) are managed by the cache management module 60. Otherwise, pages of unit page are disposed in the movable list 63. Accordingly, a page group ranks higher than or equal to the order 1 is disposed in the page buffer 65. Hereinafter, a feature of entirely managing a page chunk that is obtained by the page buffer 65 will be illustratively described.

According to various embodiments, the page buffer 65 includes a page group 65_1, a page group 65_2, a page group 65_3, a page group 65_4, a page group 65_5, and at least one page 65_6. The page buffer 65 performs at least one page allocation in relation to a specific process execution under control of the cache management module 60. For example, the page buffer 65 allocates at least one page group for each process.

The page group 65_1 is, for example, a page group in which 8 unit pages are arranged contiguously. The page group 65_1, for example, is allocated in the process 67 under control of the cache management module 60. During this, one unit page of the contiguous pages belonging to the page group 65_1 is allocated in relation to substantial data operation. If an additional data operation is required in the process 67, another unit page is additionally allocated in the page group 65_1. During this, two unit pages are allocated in the page group 65_1 for the process 67. Unit pages belonging to the page group 65_1 are allocated in relation to execution of the process 67. Unit pages allocated in relation to execution of the process 67 in the page group 65_1 are unit pages adjacent to the first provided unit page.

Similar to the page group 65_1, the page group 65_2 is, for example, a page group in which six unit pages are arranged contiguously. The page group 65_2, for example, is allocated in the process 67 under control of the cache management module 60. According to various embodiments, if there is a request for execution of the process 68 in the state that the page group 65_1 is designated in relation of execution of the process 68, the cache management module 60 includes unit pages, which belong to the page group 65_2, on a substantial data operation time of the process 68. Other unit pages belonging to the page group 65_2 are allocated thereto corresponding to an additional allocation request of the process 68.

Similar to the page group 65_1 or the page group 65_2, the page group 65_3 is, for example, a page group in which six unit pages are arranged contiguously. The page group 65_3 is designated or arranged for a specific process by the cache management module 60 if another process is allocated additionally. According to various embodiments, all unit pages of the page group 65_1 are allocated for execution of the process 67, and if the process 67 requests new memory allocation therefrom, the cache management module 60 designates or arranges the page group 65_3 to the process 67. And the cache management module 60 provides a unit page of the page group 65_3 on a data operation time of the process 67. If all unit pages of the page group 65_2 are exhausted, the cache management module 60 designates or arranges the page group 65_3 to the process 68 on a memory allocation request time for a data operation of the process 68.

The page group 65_4 is, for example, a page group in which 4 unit pages are arranged contiguously. The page group 65_1, the page group 65_2, and the page group 65_3 are designated or arranged for a specific process execution. If there is a request for memory allocation for a new process execution, the page group 65_4 is designated or arranged for its corresponding process execution. According to various embodiments, if there is a request for page allocation after pages of page groups designated to the process 67 or the process 68 are allocated, the page group 65_4 is designated for its corresponding process execution.

The page group 65_5 is, for example, a page group in which 2 unit pages are arranged contiguously. If there is a request for additional page allocation after other page groups are designated, the page group 65_5 is designated for it corresponding process execution.

The at least one page 65_6 is a page sized in one unit page. The page 65_6 is allocated for its corresponding process execution, for example, if pages of other page groups are exhausted in page allocation. According to various embodiments, one page group is designated in correspondence with a page allocation request of a specific process. If pages of the designated page group are all exhausted, the cache management module 60 performs allocation of the at least one page 65_6 in correspondence with a page allocation request.

According to various embodiments, the cache management module 60 executes a process which requests page group allocations per the above-described processes from anonymous pages. The cache management module 60 even performs an allocation of the page 65_6 for a process execution in relation to a page cache. In regard to this, the cache management module 60 determines a property of a process (e.g., whether a process is related to page cache or anonymous page request) which requests page allocation. The cache management module 60 designates page groups for a process execution related to the anonymous page and performs at least one of page allocations with pages or unit pages (e.g., the page 65_6) that belong to a page group, for a process execution related to the page cache.

According to various embodiments, the cache management module 60 manages allocated pages in accordance with their properties. For example, the cache management module 60 includes a reclaimable list 61, an unmovable list 62, and a movable list 63.

The reclaimable list 61 is a list of pages for managing roots or links of files. The unmovable list 62 is a list of unmovable pages. The movable list 63 is a list of movable pages. A CPU or the processor 120 of the electronic device 100 is prepared in plurality. Each CPU or the processor 120 includes the reclaimable list 61, the unmovable list 62, and the movable list 63, all of which are managed therein.

The cache management module 60 performs various operations in page allocation. For example, the cache management module 60 designates the page group 65_1 to the process 67 to contiguously allocate pages thereto. If pages of the page group 65_1 are exhausted and there is an additional request for page allocation, the cache management module 60 designates another page group to the process 67. Otherwise, the cache management module 60 allocates the page 65_6 to the process 67 if another page group to be designated is absent. If even the pages 65_6 are all allocated, the cache management module 67 allocates unallocated pages of another page group to the process 67. According to various embodiments, the cache management module 60 even allocates pages, which belong to the movable list 63, to the process 67. If there is no page, among pages possessed therein, to be allocated to a specific process, the cache management module 60 requests a page chunk from the buddy allocator 70 to obtain pages that are to be allocated. The cache management module 60 classifies page groups from the obtained page chunk and provides the classified page groups to the page buffer 65. According to various embodiments, page groups are provided to the page buffer 65 by the buddy allocator 70.

According to various embodiments, if a process is terminated, pages that have been allocated to the process are recovered. The cache management module 60 manages recovered pages. According to various embodiments, the cache management module 60 performs page reallocation with recovered pages in response to a specific process request. The cache management module 60 performs page group management by providing page groups of the recovered pages to the page buffer.

According to various embodiments, page retrieval causes the cache management module 60 to possess an amount of pages greater than or equal to a specific number (e.g., 31). In this condition, the cache management module 60 restores a specific number of pages to the buddy allocator 70. For example, the cache management module 60 restores a page chunk (e.g., 31 pages) to the buddy allocator 70. In a course of restoration, the cache management module 60 forms a page chunk with contiguous pages. According to various embodiments, the cache management module 60 forms page chunks, which are to be restored, in the order of page groups possessing the largest contiguous pages. Otherwise, the cache management module 60 forms a page chunk with pages or page groups in the order of a smaller number of contiguous pages.

According to various embodiments, the cache management module 60 performs page restoration to maintain a specific number of pages. For example, the cache management module 60 restores the rest of pages, except a specific number of pages (e.g., 31 pages), to the buddy allocator 70. According to various embodiments, the cache management module 60 possesses a page group with a relatively large number of contiguous pages, and restores the rest of page groups or pages to the buddy allocator 70. According to various embodiments, the cache management module 60 operates to maintain a ratio between page groups with a relatively large number of contiguous pages and page groups (or pages) with a relatively small number of contiguous pages on a specific rate and restores the rest of pages or page groups to the buddy allocator 70.

According to various embodiments, the cache management module 60 allocates pages of a specific process in the movable list 63 unless an allocation request is related to anonymous pages. According to various embodiments, if there is a request for page allocation related to its relevant process under the state that the process has ever had a page group, the cache management module 60 allocates a page from recently used pages which are used in their page group. According to various embodiments, if a process requesting page allocation does not have a page group, the cache management module 60 allocates a page group in the page buffer.

According to various embodiments, the cache management module 60 fetches page groups, which rank lower than or equal to a specific order, regardless of a specific number (e.g., 31 pages) assigned to the cache management module 60. Otherwise, the cache management module 60 fetches page groups, which rank lower than or equal to a specific order, in a number that is confined in a specific range. During this, the cache management module 60 modifies the number of pages from 31 into 70.

According to various embodiments, unless further contiguous page groups are present in the buddy allocator 70, the cache management module 60 allocates a page from the movable list 62, in relation to execution of a specific process or allocates a unit page which ranks the order 0. Unless a page to be allocated is present in the movable list 63, the cache management module 60 shifts a recently used page group to the movable list 63 and then allocate a page in its corresponding page group. The cache management module 60 returns a page group, which has pages greater than or equal to a specific number, to the buddy allocator 70.

Memory allocation related to hardware unit usually requires contiguous pages. An I/O memory managing unit (IOMMU) 80 performs address conversion for pages, which are divisionally disposed in a physical memory, to allow the pages to act as contiguous pages in a virtual memory state. If the kernel 141 changes a physical memory location of a specific page, the IOMMU 80 updates a location change corresponding thereto. In regard to this, the IOMMU 80 prepares an address table and updates the address table to support management of movable pages.

As described above, in various embodiments, an electronic device according to various embodiments includes an application to request page allocation of a process, a cache management module to allocate a page in a page group including uninterrupted (or consecutive, or contiguous) pages to the process, and a page buffer to manage at least one page group.

According to various embodiments, if there is a page group designated to a process, the cache management module allocates a page, which belongs to the page group corresponding thereto, to the process.

According to various embodiments, the cache management module allocates a page, which is adjacent to a page which is allocated in a page group, to a process.

According to various embodiments, unless there is a page group designated to a process, the cache management module a page, which belongs to a new page group, to the process.

According to various embodiments, unless there is a new page group, the cache management module allocates non-contiguous pages or a page which belongs to a page group designated to another process.

According to various embodiments, unless there is a new page group, the cache management module obtains a page chunk which includes a page group ranking lower than or equal to a specific order and allocates a page in a page group which belongs to the obtained page chunk.

According to various embodiments, the cache management module determines whether a process is related to an anonymous page. If a process is determined as relating to an anonymous page, the cache management module allocates a page in a page group. If a process is determined as relating to a page cache, the cache management module allocates a non-contiguous page.

According to various embodiments, the cache management module allocates a page that belongs to a movable list in which movable pages are disposed.

According to various embodiments, if a process is terminated, the cache management module retrieves a page group that is allocated to the process.

According to various embodiments, if the number of retrieved and unallocated pages is greater than or equal to a specific number, the cache management module forms page groups into page chunks with a specific number which are to be restored in priority.

As described above, in various embodiments, an electronic device according to various embodiments includes a memory to store an application necessary for execution of at least one process and provide a page related to execution of the process, and at least one processor (e.g., cache management module) connected with the memory. The memory stores at least one instruction that is executed by the processor. The instruction includes an instruction for requesting page allocation of a process related to execution of the application, and an instruction for allocating a page in a page group which includes uninterrupted (or consecutive, or contiguous) pages to the process when there is a request for the page allocation.

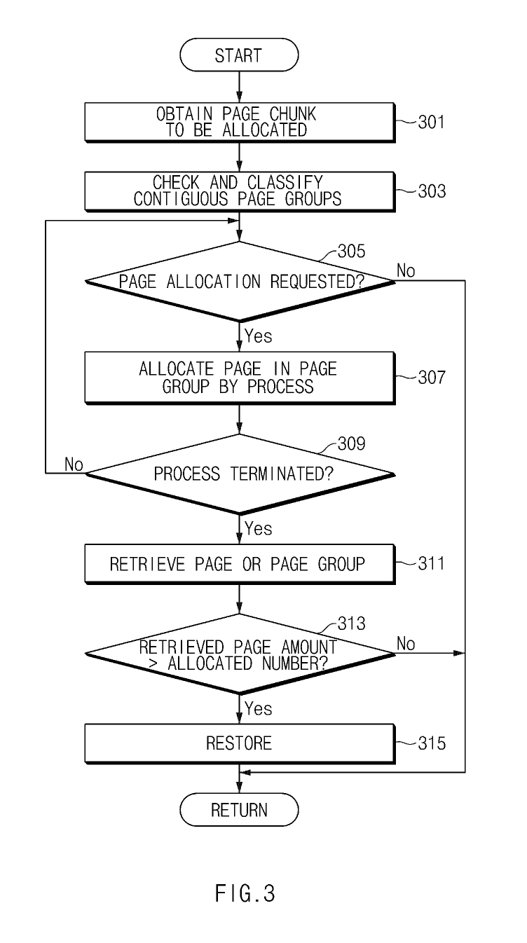

FIG. 3 illustrates a memory allocating method according to various embodiments of the present disclosure.

Referring to FIG. 3, in the memory allocating method, at operation 301, the memory management module 170 obtains a page chunk which is to be allocated. This page chunk is pages of a specific number which are obtained by the cache management module 60 from the buddy allocator 70 in one time. For example, the cache management module 60 obtains 31 pages from the buddy allocator 70. The buddy allocator 70 provides a page chunk, which includes at least one unit page or at least one page group, to the cache management module 60 in response to a request of the cache management module 60. According to various embodiments, the buddy allocator 70 provides page groups, which rank lower than or equal to a specific order, to the cache management module without limit (e.g., without limit to 31 pages). Otherwise, the buddy allocator 70 provides page groups, which rank lower than or equal to a specific order within a specific range (e.g., 70 pages in number) greater than or equal to a specific limit (e.g., 31 pages limit in number), to the cache management module 60. During this, the number of page chunks is changeable. To provide page groups that rank on a specific order, the buddy allocator 70 forms a page chunk from page groups having a relatively high order.

According to various embodiments, the buddy allocator 70 provides page groups in relation to an application process execution for allocation of movable pages. Otherwise, the buddy allocator 70 provides page groups in relation to page allocation of a process for an anonymous page execution. The buddy allocator 70 provides a page chunk in a unit page during page allocation of a process for page cache execution.

At operation 303, the memory management module 170 checks and classifies contiguous page groups. The cache management module 60 of the memory management module 170 checks page groups in a page chunk that is obtained from the buddy allocator 70. For example, the cache management module 60 classifies page groups by the number of contiguous pages in a page chunk. After the classification, the cache management module 60 provides the page groups to the page buffer 65. The cache management module 60 designates pages, which rank on the order 0, to the movable list 63. According to various embodiments, the cache management module 60 provides at least one of a page group and a page to the page buffer 65.

At operation 305, the memory management module 170 determines whether there is a request for page allocation. Unless there is a page allocation request, the memory management module 170 ships the following operations described below. If there is a page allocation request, the memory management module 170 allocates a page in a page group by process at operation 307. For example, if there is a request for page allocation in relation to a specific process, the cache management module 60 of the memory management module 170 checks existence of a page group which is designated to the process. If there is a page group designated to a process, the cache management module 60 allocates a page, which belongs to the page group corresponding thereto, to the process. During this, the cache management module 60 allocates a page which is adjacent to a recently allocated page in a page group.

Unless there is a page group allocated to a process, the cache management module 60 of the memory management module 170 designates a new page group. The cache management module 60 allocates a specific page (a first, last, or anonymous page of a page group) in a new page group for a process execution.

Unless there is a page group allocated to a process, the cache management module 60 of the memory management module 170 allocates a unit page for a process execution corresponding thereto. This unit page is a page which is disposed in the movable list 63. Otherwise, the cache management module 60 allocates a page that is designated to another process. The cache management module 60 allocates a page in a page group with which page allocation has lapsed a specific time or has occurred most long ago. Otherwise, unless there is a page to be allocated in the movable list 63, the cache management module 60 allocates a page of a page group that is designated to another process.

According to various embodiments, unless there is a page group to be designated, the cache management module 60 obtains a page chunk, which includes page groups ranking lower than or equal to a specific order, from the buddy allocator 70, and designates one of the page groups, which are included in the obtained page chunk, to a process. During this, the cache management module 60 designates a page group, which has the largest number of contiguous pages, or an anonymous page group to a process. According to various embodiments, the cache management module 60 designates a page group, with which page allocation has lapsed a specific time or has occurred most long ago, for a process. The cache management module 60 obtains and allocates page chunks in a specific number (e.g., 186 page chunks). According to various embodiments, if page allocation with a page group designated for a specific process is terminated, the memory management module 170 designates a new page group.

At operation 309, the memory management module 170 determines whether a process is terminated. Unless a process is terminated, the memory management module 170 branches out prior to the operation 305 and control a page to be allocated to the same process in the same page group in response to generation of a memory allocation request.

If a specific process is terminated, at operation 311, the memory management module 170 retrieves a page or a page group. The memory management module 170 determines whether an amount of retrieved pages is greater than or equal to a specific number (e.g., 31 pages). If an amount of retrieved pages (the total amount of pages managed by the cache management module 60) is greater than or equal to a specific number, the memory management module 170 restores at least a part of the retrieved pages at operation 315. For example, the memory management module 170 restores 31 pages to the buddy allocator 70. The memory management module 170 first selects page groups, which are formed of contiguous pages, to constitute pages which are to be restored. Otherwise, the memory management module 170 selects page groups, which are to be restored, in a size of contiguous pages to make up a specific number that is to be restored. If an amount of retrieved pages is smaller than or equal to a specific number, the memory management module 170 skips a restoring work of the operation 315. Pages smaller than or equal to a specific number are reallocated in relation to a new process execution in accordance with management of the cache management module 60 that is employed by a processor or CPU.

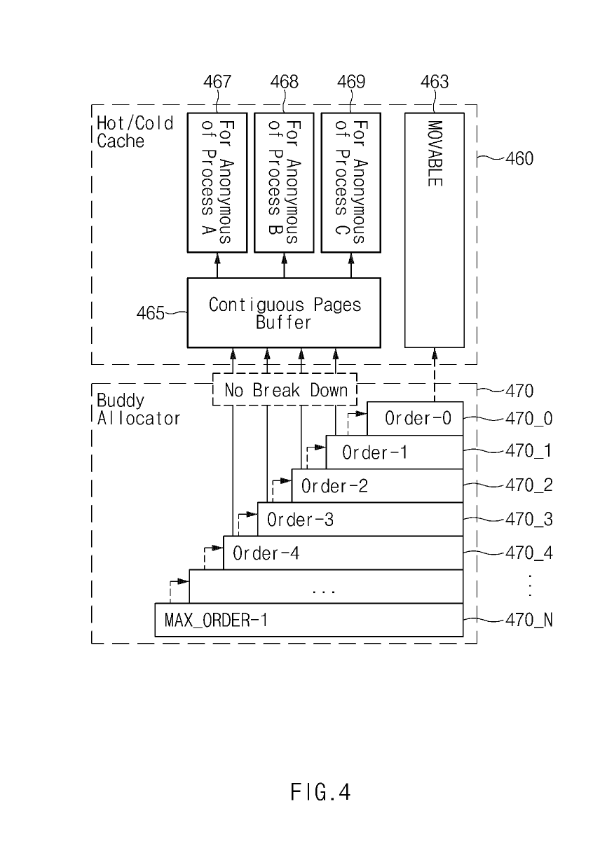

FIG. 4 illustrates another example of management module according to embodiments of the present disclosure.

Referring to FIG. 4, a memory management module 400 according to various embodiments provides page groups, which are disposed with ranks lower than or equal to a specific order (square) in a buddy allocator 470, to a page buffer 465 of a cache management module 460. In regard to this, the buddy allocator 470 includes a page group 470_0, a page group 470_1, a page group 470_2, a page group 470_3, a page group 470_4, . . . , and a page group 470_N. The page group 470_0, as a page group ranking on an order of 0, is a unit page. The page group 470_1, as a page group ranking on an order of 1, is a page group that is formed of two pages. The page group 470_2, as a page group ranking on an order of 2, is a page group that is formed of four pages. The page group 470_3, as a page group ranking on an order of 3, is a page group that is formed of eight pages. The page group 470_4, as a page group ranking on an order of 4, is a page group that is formed of sixteen pages. The page group 470_N, as a page group ranking on an order of N, is a page group which is formed of 2N pages (N is a natural number).

The cache management module 460 obtains a page or page groups, which rank lower than or equal to a specific order, from the buddy allocator 470 without split. In regard to this, the buddy allocator 470 processes a composition ratio of the page groups, which are provided to the cache management module 460, in a specific rate. Otherwise, the buddy allocator 470 adjusts a composition ratio of a page chunk in accordance with an amount of page groups that are possessed at present. For example, the buddy allocator 470 disposes the page group 470_4 in one, the page group 470_3 in one, the page group 470_2 in one, the page group 470_1 in one, and the page group 470_0 in one. According to various embodiments, the buddy allocator 470 adjusts a limit number of page chunks which are to be provided to the cache management module 460. For example, the buddy allocator 470 adjusts a limit number of page chunks into a specific number (e.g., a specific one of 1˜186) and makes up page groups, which rank lower than or equal to a specific order, in a ratio greater than or equal to a specific number.

The cache management module 460 includes a page buffer 465, and a movable list 463, and additionally include a process 467 related to an anonymous page, a process 468 related to an anonymous page, and a process 469 related to an anonymous page. The cache management module 469 first designates page groups for the process 467, the process 468, and the process 469 which are related to anonymous pages. According to various embodiments, if there is a request for page allocation related to page cache, the cache management module 460 allocates a page (e.g., a unit page) that is designated in the movable list 463.

As described above, in various embodiments, a memory allocating method according various embodiments includes operations of requesting page allocation for a process and allocating a page in a page group which includes pages continuous to the process.

According to various embodiments, if there is a page group which is designated to the process, the allocating operation includes an operation of allocating a page that belongs to the page group corresponding thereto.

According to various embodiments, the allocating operation includes an operation of allocating a page which is adjacent to a page allocated in the page group.

According to various embodiments, unless there is a page group designated to a process, the allocating operation allocates a page which belongs to a new page group.

According to various embodiments, the allocating operation includes an operation of allocating a non-contiguous page unless there is a new page group or allocating a page that belongs to a page group designated to another process.

According to various embodiments, the allocating operation includes operations of obtaining a page chunk that includes a page group ranking lower than or equal to a specific order unless there is a new page group and allocating a page in a page group which is included in the obtained page chunk.

According to various embodiments, the memory allocating method further includes operations of determining whether a process requesting page allocation is related to an anonymous page, allocating a page in the page group if the process is related to the anonymous page, and allocating a non-contiguous page if the process is related to a page cache.

According to various embodiments, the page allocating operation includes an operation of allocating a page which belongs to a movable list in which movable pages are disposed.

According to various embodiments, the memory allocating method further includes an operation of retrieving a page group which is allocated to the process if the process is terminated.

According to various embodiments, the memory allocating method further includes an operation of forming page chunks, whose page groups are to be first restored, if the number of the retrieved pages and unallocated pages are greater than or equal to a specific number.

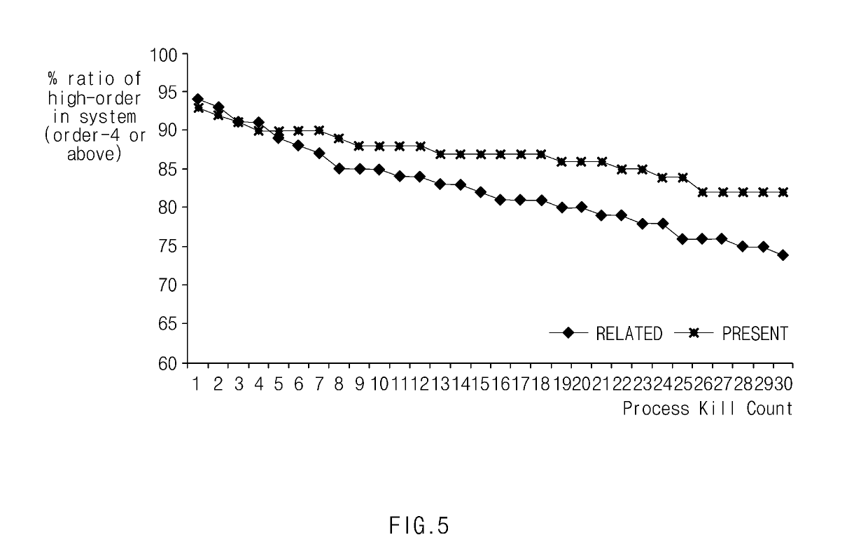

FIG. 5 illustrates page variations relevant to memory allocation according to various embodiments of the present disclosure.

Referring to FIG. 5, the graph thereof shows variations of contiguous pages of a free memory, resulting from a low memory killer (LMK) test of a related electronic device, and variations of pages based on page group allocation according to various embodiments described above. The orders ranking in the graphic result is comparatively referred to the order rate higher than or equal to the order of 4. As shown in the graph of FIG. 5, it can be seen that, relative to the related feature, a system based on page group allocation provided by various embodiments of the present disclosure include relatively high-order page groups (e.g., page groups with a relatively high number of contiguous pages). Based on this result, the electronic device 100 is advantageous to reducing a time for memory allocation to improve a response rate of user function performance.

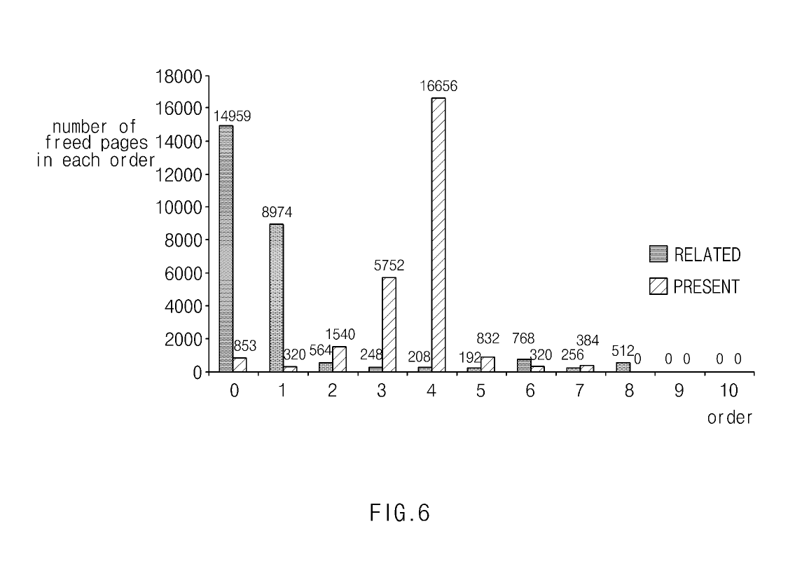

FIG. 6 illustrates page variations of a freed memory according to various embodiments of the present disclosure.

Referring to FIG. 6, the graph thereof shows variations of page groups by memory allocation of applications that perform 100 MB memory allocation in micro benchmark circumstances. The graphic results of FIG. 6 shows page variations by application execution, home key input, and execution of a back key (an application end key) after execution of another application. As shown in FIG. 6, it can be seen than, relative to the related feature, a feature provided from various embodiments of the present disclosure is helpful in raising a rate of page groups with specific orders (e.g., the orders of 3 and 4).

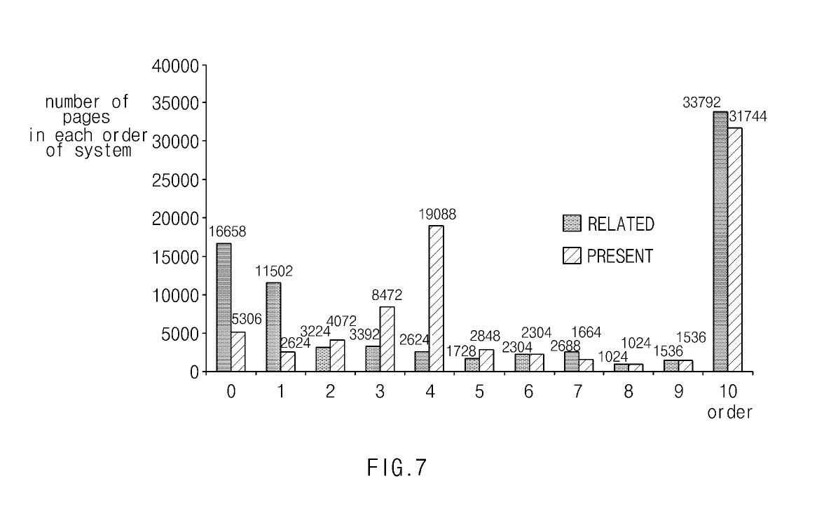

FIG. 7 illustrates page variations of a system memory according to various embodiments of the present disclosure.

In FIG. 7, the system memory is variable with a large rate of difference at specific orders (e.g., the orders of 3 and 4) depending on execution and termination of plural applications in micro benchmark circumstances. As a result, the electronic device 100 provides page groups, which correspond to the orders of 3 and 4, in relation to execution of applications, thus supporting fast allocation, retrieval, and restoration of pages relative to the related feature that provides unit pages in fragmentation.

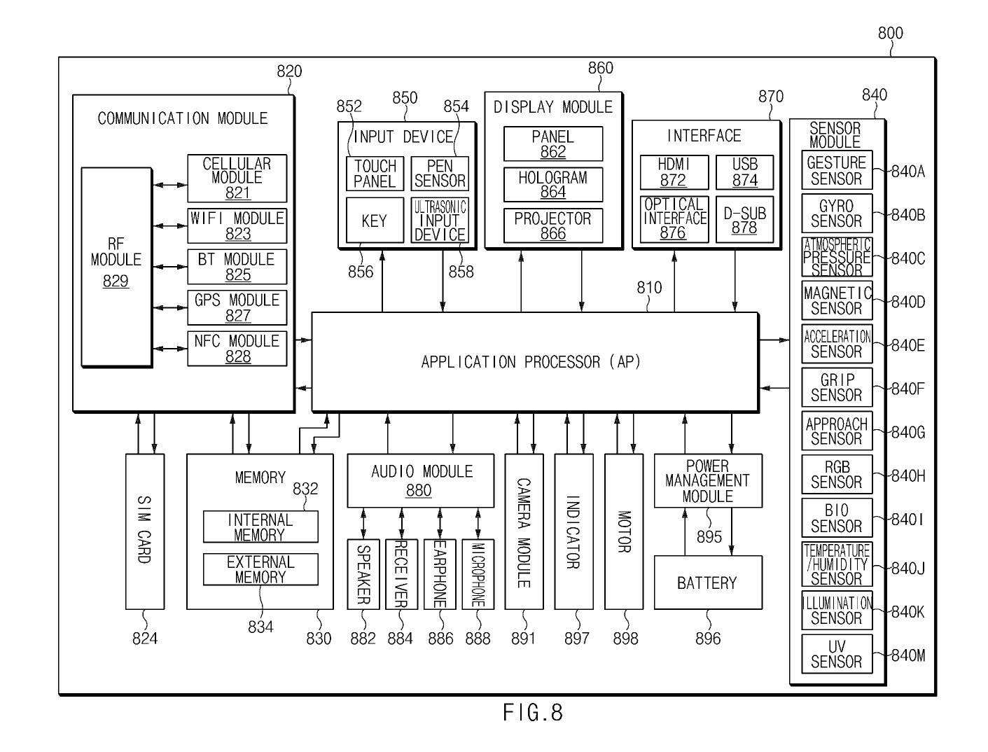

FIG. 8 illustrates another example of an electronic device related to memory allocation according to various embodiments of the present disclosure.

Referring to FIG. 8, the electronic device 800 includes, for example, all or a part of elements of the electronic device 100 shown in FIG. 1. Referring to FIG. 8, the electronic device 800 includes at least one of one or more application processors (AP) 810, a communication module 820, a subscriber identification module (SIM) card 824, a memory 830, a sensor module 840, an input unit 850, a display 860, an interface 870, an audio module 880, a camera module 891, a power management module 895, a battery 896, an indicator 897, or a motor 898.

The processor (AP) 810 drives an operating system (OS) or an application to control a plurality of hardware or software elements connected to the AP 810 and processes and computes a variety of data including multimedia data. The AP 810 is implemented with a system-on-chip (SoC), for example. According to various embodiments, the AP 810 further includes a graphic processing unit (GPU) or an image signal processor. The AP 810 includes at least a part of the elements shown in FIG. 8. The AP 810 processes instructions or data, which are received from at least one of other elements (e.g., a nonvolatile memory), and stores diverse data into such a nonvolatile memory.

The communication module 820 includes a configuration that is the same as or similar to the communication interface 160 of FIG. 1. The communication module 820 includes a cellular module 821, a WiFi module 823, a BLUETOOTH (BT) module 825, a GPS module 827, an NFC module 828, and a radio frequency (RF) module 829.

The cellular module 821 provides voice call, video call, a character service, or an Internet service through a communication network. According to various embodiments, the cellular module 821 performs discrimination and authentication of an electronic device within a communication network using a subscriber identification module (e.g., a SIM card) 824. According to various embodiments, the cellular module 821 performs at least a portion of functions that the AP 810 provides. According to various embodiments, the cellular module 821 includes a communication processor (CP).

Each of the WiFi module 823, the BT module 825, the GPS module 827, and the NFC module 828 includes a processor for processing data exchanged through a corresponding module, for example. In some embodiments, at least a part (e.g., two or more elements) of the cellular module 821, the WiFi module 823, the BT module 825, the GPS module 827, and the NFC module 828 is included within one integrated circuit (IC) or an IC package.

The RF module 829 transmits and receives, for example, communication signals (e.g., RF signals). The RF module 829 includes a transceiver, a power amplifier module (PAM), a frequency filter, a low noise amplifier (LNA), or an antenna. According to another embodiment, at least one of the cellular module 821, the WiFi module 823, the BLUETOOTH module 825, the GPS module 827, and the NFC module 828 transmits and receives an RF signal through a separate RF module.

The SIM card 824 includes, for example, a card, which has a subscriber identification module, or an embedded SIM and includes unique identifying information (e.g., integrated circuit card identifier (ICCID)) or subscriber information (e.g., integrated mobile subscriber identify (IMSI)).

The memory 830 (e.g., the memory 130) includes, for example, an embedded memory 832 or an external memory 834. For example, the embedded memory 832 includes at least one of a volatile memory (e.g., a dynamic RAM (DRAM), a static RAM (SRAM), a synchronous dynamic RAM (SDRAM), etc.), a nonvolatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a NAND flash memory, a NOR flash memory, etc.), a hard drive, or solid state drive (SSD).

The external memory 834 further includes a flash drive, for example, a compact flash (CF), a secure digital (SD), a micro-secure digital (SD), a mini-SD, an extreme digital (xD), or a memory stick. The external memory 834 is functionally connected with the electronic device 800 through various interfaces.

The sensor module 840 measure, for example, a physical quantity, or detect an operation state of the electronic device 800, to convert the measured or detected information to an electric signal. The sensor module 840 include at least one of a gesture sensor 840A, a gyro sensor 840B, a pressure sensor 840C, a magnetic sensor 840D, an acceleration sensor 840E, a grip sensor 840F, a proximity sensor 840G, a color sensor 840H (e.g., RGB sensor), a living body sensor 840I, a temperature/humidity sensor 840J, an illuminance sensor 840K, or an UV sensor 840M. The sensor module 840 further includes an E-nose sensor, an electromyography sensor (EMG) sensor, an electroencephalogram (EEG) sensor, an electrocardiogram (ECG) sensor, an infrared (IR) sensor, an iris sensor, or a fingerprint sensor, for example. The sensor module 840 further includes a control circuit for controlling at least one or more sensors included therein. In certain embodiments, the electronic device 801 further includes a processor, which is configured to control the sensor module 840, as a part of or an additional element, thus controlling the sensor module 840 while the processor 810 is in a sleep state.

The input unit 850 includes, for example, a touch panel 852, a (digital) pen sensor 854, a key 856, or an ultrasonic input unit 858. The touch panel 852 recognizes, for example, a touch input using at least one of a capacitive type, a resistive type, an infrared type, or an ultrasonic wave type. Additionally, the touch panel 852 further includes a control circuit. The touch panel 852 further includes a tactile layer to provide a tactile reaction for a user.

The (digital) pen sensor 854 is a part of the touch panel 852, or a separate sheet for recognition. The key 856, for example, includes a physical button, an optical key, or a keypad. The ultrasonic input unit 858 allows the electronic device 800 to detect a sound wave using a microphone (e.g., a microphone 888) and determines data through an input tool generating an ultrasonic signal.

The display 860 (e.g., the display 760) includes a panel 862, a hologram device 864, or a projector 866. The panel 862 includes the same or similar configuration with the display 150 of FIG. 1. The panel 862, for example, is implemented to be flexible, transparent, or wearable. The panel 862 and the touch panel 852 are implemented with one module. The hologram device 864 shows a three-dimensional image in a space using interference of light. The projector 866 projects light onto a screen to display an image. The screen, for example, is positioned in the inside or outside of the electronic device 800. According to various embodiments, the display 860 further includes a control circuit for controlling the panel 862, the hologram device 864, or the projector 866.

The interface 870, for example, includes a high-definition multimedia interface (HDMI) 872, a USB 874, an optical interface 876, or a D-sub (D-subminiature) 878. The interface 870 includes, for example, the communication interface 160 shown in FIG. 1. The interface 870, for example, includes a mobile high definition link (MHL) interface, an SD card/multi-media cared (MMC) interface, or an Infrared data association (IrDA) standard interface.

The audio module 880 converts a sound and an electric signal in dual directions. At least one element of the audio module 880 includes, for example, the I/O interface 125 shown in FIG. 1. The audio module 880, for example, processes sound information that is input or output through the speaker 882, the receiver 884, the earphone 886, or the microphone 888.

The camera module 891 is a unit that is capable of taking a still picture and a moving picture. According to various embodiments, the camera module 891 includes one or more image sensors (e.g., a front sensor or a rear sensor), a lens, an image signal processor (ISP), or a flash (e.g., an LED or a xenon lamp).

The power management module 895 manages, for example, power of the electronic device 800. The power management module 895 includes, for example, a power management integrated circuit (PMIC) a charger integrated circuit (IC), or a battery or fuel gauge. The PMIC operates in wired or wireless charging mode. A wireless charging mode includes, for example, diverse types of magnetic resonance, magnetic induction, or electromagnetic wave. For the wireless charging, an additional circuit, such as a coil loop circuit, a resonance circuit, or a rectifier, is further included therein. The battery gauge, for example, measures a remnant of the battery 896, a voltage, a current, or a temperature during charging. The battery 896 measures, for example, a residual, a voltage on charge, a current, or temperature thereof. The battery 896 includes, for example, a rechargeable battery or a solar battery.

The indicator 897 displays the following specific state of the electronic device 800 or a part (e.g., the AP 810) thereof: a booting state, a message state, or a charging state. The motor 898 converts an electric signal into mechanical vibration and generates a vibration or haptic effect. Although not shown, the electronic device 800 includes a processing unit (e.g., a GPU) for supporting a mobile TV. The processing unit for supporting the mobile TV, for example, processes media data that is based on the standard of digital multimedia broadcasting (DMB), digital video broadcasting (DVB), or media flow (MediaFlo™).

Each of the above-described elements of the electronic device according to various embodiments of the present disclosure can be implemented using one or more components, and a name of a related component may vary with on the kind of the electronic device. The electronic device according to various embodiments of the present disclosure includes at least one of the above components. Also, a part of the components may be omitted, or additional other components may be further included. Also, some of the components of the electronic device according to the present disclosure can be combined to form one entity, thereby making it possible to perform the functions of the related components substantially the same as before the combination.

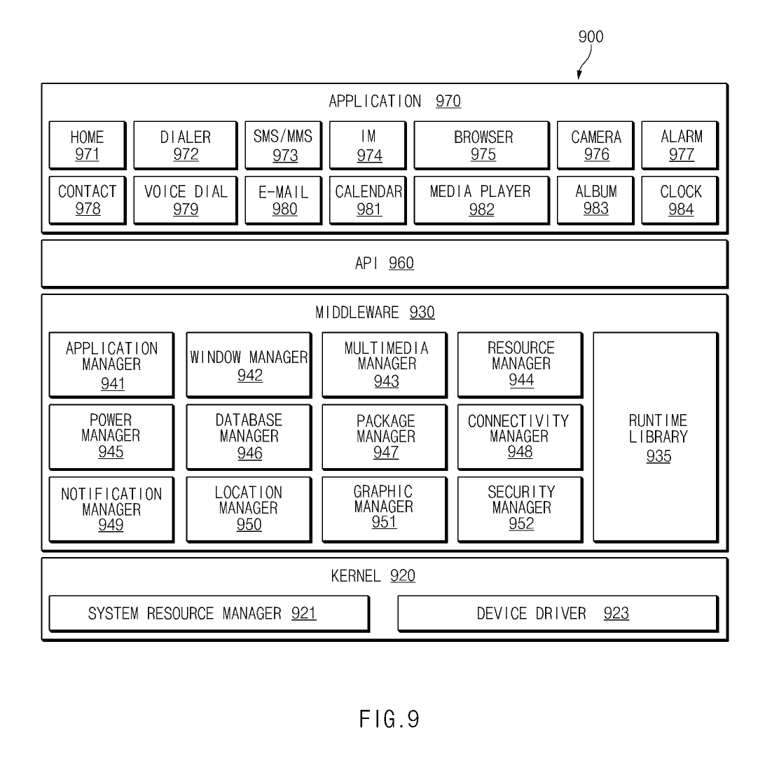

FIG. 9 illustrates a block diagram of a program module according to various embodiments of the present disclosure.

Referring to FIG. 9, according to various embodiments, the program module 910 includes configurations relevant to the program 140 that are described above in conjunction with FIG. 1. For example, the program module 910 includes an operating system (OS) to control resources relevant to an electronic device (e.g., the electronic device 100), and/or diverse applications (e.g., the application 147 of FIG. 1) driven on the operating system. The operating system is, for example, ANDROID, iOS, WINDOWS, SYMBIAN, TIZEN, or BADA.

The program module 910 includes an OS and an application 970. The OS includes a kernel 920, a middleware 930, and an API 960. At least a part of the program module 910 is preloaded on an electronic device or is downloadable from a server (e.g., the server system 104).

The kernel 920 (e.g., the kernel 141 of FIG. 1) includes, for example, a system resource manager 921 or a device driver 923. The system resource manager 921 performs control, allocation, or retrieval of system resources. According to various embodiments, the system resource manager 921 includes a process managing part, a memory managing part, or a file system managing part. The device driver 923 includes, for example, a display driver, a camera driver, a BLUETOOTH driver, a common memory driver, an USB driver, a keypad driver, a WiFi driver, an audio driver, or an inter-process communication (IPC) driver.

The middleware 930 provides, for example, a function necessary for the application 970 in common, or provide diverse functions to the application 970 through the API 960 to allow the application 970 to efficiently use limited system resources of the electronic device. According to various embodiments, the middleware 930 (e.g., the middleware 143) includes at least one of a runtime library 935, an application manager 941, a window manager 942, a multimedia manager 943, a resource manager 944, a power manager 945, a database manager 946, a package manager 947, a connectivity manager 948, a notification manager 949, a location manager 950, a graphic manager 951, or a security manager 952.

The runtime library 935 includes, for example, a library module which is used by a compiler to adding a new function through a programming language while the application 970 is being executed. The runtime library 935 performs input/output management, memory management, or capacities about arithmetic functions.

The application manager 941 manages, for example, a life cycle of at least one application of the application 970. The window manager 942 manages a GUI resource that is used in a screen. The multimedia manager 943 identifies a format necessary for playing diverse media files and performs an encoding or decoding work for media files by using a codec suitable for the format. The resource manager 944 manages resources such as a storage space, memory, or source code of at least one application of the application 970.

The power manager 945, for example, operates with a basic input/output system (BIOS) to manage a battery or power and provides power information for an operation of an electronic device. The database manager 946 generates, searches, or modifies a database that is to be used in at least one application of the application 970. The package manager 947 installs or updates an application which is distributed in a form of package file.

The connectivity manager 948 manages, for example, wireless connection such as WiFi or BLUETOOTH. The notification manager 949 displays or notifies an event such as arrival message, promise, or proximity notification in a mode that does not disturb a user. The location manager 950 manages location information of an electronic device. The graphic manager 951 manages a graphic effect that is provided to a user or manages a user interface relevant thereto. The security manager 952 provides a general security function necessary for system security or user authentication. According to various embodiments, if an electronic device (e.g., the electronic device 100) includes a telephony function, the middleware 930 further includes a telephony manager for managing a voice or image call function of the electronic device.

The middleware 930 includes a middleware module to form a combination of diverse functions of the above-described elements. The middleware 930 provides a specialized module by a kind of OS in purpose of offering differentiated functions. Additionally, the middleware 930 removes a part of the preexisting elements, dynamically, or add a new element thereto.

The API 960 (e.g., the API 145) is, for example, a set of programming functions, and is provided in a configuration which is variable depending on an OS. For example, if an OS is the ANDROID or the iOS, it is permissible to provide one API set per platform. If an OS is the TIZEN, it is permissible to provide two or more API sets per platform.

The application 970 (e.g., the application 147) includes, for example, one or more applications capable of providing functions for a home 971, a dialer 972, an SMS/MMS 973, an instant message (IM) 974, a browser 975, a camera 976, an alarm 977, a contact 978, a voice dial 979, an e-mail 980, a calendar 981, a media player 982, am album 983, and a timepiece 984, or for offering health care (e.g., measuring an exercise quantity or blood sugar) or environmental information (e.g., atmospheric pressure, humidity, or temperature).

According to various embodiments, the application 970 includes an application (hereinafter, referred to as “information exchanging application” for descriptive convenience) to support information exchange between the electronic device (e.g., the electronic device 100) and an external electronic device (e.g., the second electronic device 102). The information exchanging application includes, for example, a notification relay application for transmitting specific information to the external electronic device, or a device management application for managing the external electronic device.

For example, the information exchanging application includes a function of transmitting notification information, which arise from other applications (e.g., the applications for SMS/MMS, e-mail, health care, or environmental information), to an external electronic device (e.g., the second electronic device 102). Additionally, the information exchanging application, for example, receives notification information from an external electronic device and provides the notification information to a user. The device management application manages (e.g., install, delete, or update), for example, at least one function (e.g., turn-on/turn-off of an external electronic device itself (or a part of components) or adjustment of brightness (or resolution) of a display) of the external electronic device (e.g., the second electronic device 102) that communicates with the electronic device 100, an application operating in the external electronic device, or service (e.g., call service or message service) provided from the external electronic device.

According to various embodiments, the application 970 includes an application (e.g., a health care application) that is assigned thereto in accordance with a property (e.g., a property of a mobile medical device as a kind of electronic device) of the external electronic device (e.g., the second electronic device 102). According to various embodiments, the application 970 includes an application that is received from an external electronic device (e.g., the second electronic device 102). According to various embodiments, the application 970 includes a preloaded application or a third party application which is downloadable from a server. The titles of the program module 910 according to the illustrated embodiment are modifiable depending on kinds of OSs.

According to various embodiments, at least a part of the program module 910 is implemented in software, firmware, hardware, or at least two or more combinations among them. At least a part of the program module 910, for example, is implemented (e.g., executed) by a processor (e.g., the AP 810). At least a part of the program module 910 includes, for example, a module, a protein, a set of instructions, or a process for performing one or more functions.

The term “module” used for the present disclosure, for example, means a unit including one of hardware, software, and firmware or a combination of two or more thereof. A “module,” for example, is interchangeably used with terminologies such as a unit, logic, a logical block, a component, a circuit, etc. The “module” is a minimum unit of a component integrally configured or a part thereof. The “module” is a minimum unit performing one or more functions or a portion thereof. The “module” is implemented mechanically or electronically. For example, the “module” according to various embodiments of the present disclosure included at least one of an application-specific integrated circuit (ASIC) chip performing certain operations, a field-programmable gate arrays (FPGAs), or a programmable-logic device, those of which have been known or to be developed in the future.

At least a part of an apparatus (e.g., modules or functions thereof) or a method (e.g., operations) according to various embodiments of the present disclosure, for example, is implemented by instructions stored in a computer-readable storage medium in the form of a programmable module. The instruction, when executed by a processor (e.g., the processor 120) performs a function corresponding to the instruction. Such a computer-readable medium is, for example, the memory 130.

The computer-readable recording medium included a hard disk, a magnetic media such as a floppy disk and a magnetic tape, an optical media such as compact disc read only memory (CD-ROM) and a digital versatile disc (DVD), a magneto-optical media such as a floptical disk, and the following hardware devices specifically configured to store and perform a program instruction (e.g., a programming module): read only memory (ROM), random access memory (RAM), and a flash memory. Also, a program instruction includes not only a mechanical code, such as things generated by a compiler, but also a high-level language code executable on a computer using an interpreter. The above hardware unit is configured to operate via one or more software modules for performing an operation of the present disclosure, and vice versa.

A module or a programming module according to various embodiments of the present disclosure includes at least one of the above elements, or a part of the above elements is omitted, or additional other elements is further included. Operations performed by a module, a programming module, or other elements according to various embodiments of the present disclosure are executed sequentially, in parallel, repeatedly, or in a heuristic method. Also, a portion of operations is executed in different sequences, omitted, or other operations are added thereto.

According to various embodiments, a computer-readable recording medium according to various embodiments include an instruction which is executable by at least one processor. The instruction is set to perform an operation of requesting page allocation of a process, an operation of allocating pages in a page group including uninterrupted (or consecutive, or contiguous) pages to the process.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A memory allocating method comprising:
requesting a page allocation for a process related to an operation of an application; and
allocating a page to the process in a page group, wherein the page group contains contiguous pages associated with the operation of the application.

2. The memory allocating method of claim 1, wherein the page belongs to a designated page group of the process.

3. The memory allocating method of claim 2, wherein the page is adjacent to another page allocated in the page group.

4. The memory allocating method of claim 1, wherein the page belongs to a new page group.

5. The memory allocating method of claim 4, wherein the page comprises:
when the new page group is not present, a non-contiguous page or another page that belongs to a page group designated to another process.

6. The memory allocating method of claim 4, wherein the page comprises:
unless the new page group is present, a page chunk including a page group that ranks lower than or equal to a specific order and another page in a page group that belongs to the page chunk.

7. The memory allocating method of claim 1, further comprising:
determining whether the process requesting the page allocation is related to an anonymous page; and
allocating a page in the page group if the process is related to the anonymous page, or allocating a non-contiguous page if the process is related to a page cache.

8. The memory allocating method of claim 7, wherein the page belongs to a movable list in which movable pages are disposed.

9. The memory allocating method of claim 1, further comprising:
retrieving, if the process is terminated, a page group that is allocated to the process.

10. The memory allocating method of claim 9, further comprising:
forming at least one page chunk of a specific number that is prepared to first restore page groups if the number of the retrieved pages and unallocated pages are greater than or equal to a specific number.

11. An electronic device comprising:
a memory element stored an application to request a page allocation of a process;
a processor coupled to the memory element, wherein the processor is configured to control:
a cache management module to allocate a page in a page group including consecutive pages of the process; and
a page buffer to manage the at least one page group.

12. The electronic device of claim 11, wherein the page belongs to a designated page group.

13. The electronic device of claim 12, wherein the page is adjacent to another page belonging in the page group.

14. The electronic device of claim 11, wherein the page belongs to a new page group.

15. The electronic device of claim 14, wherein the page comprises, when the new page group is not present, a non-contiguous page or another page that belongs to a page group designated to another process.

16. The electronic device of claim 14, wherein the page comprises, unless the new page group is present, at least one page chunk including a page group that ranks lower than or equal to a specific order and another page in a page group that belongs to the page chunk.

17. The electronic device of claim 11, wherein the processor is further configured to control the cache management module to determine whether a process requesting the page allocation is related to an anonymous page, allocate a page in the page group if the process is related to the anonymous page, or allocate a non-contiguous page if the process is related to a page cache.

18. The electronic device of claim 17, wherein the page belongs to a movable list in which movable pages are disposed.

19. The electronic device of claim 11, wherein the processor is further configured to control the cache management module to retrieve a page group, which is allocated to the process, if the process is terminated.

20. The electronic device of claim 19, wherein the processor is further configured to control the cache management module to form at least one page chunk of a specific number that is prepared to first restore page groups if the number of the retrieved pages and unallocated pages are greater than or equal to a specific number.
